(19) United States
(12) Patent Application Publication
(10) Pub. No.: US 2026/0352316 A1
(43) Pub. Date: Nov. 5, 2026

(54) WIRELESS RELAY DEVICE AND WIRELESS RELAY METHOD

(71) Applicant: NTT, Inc., Tokyo (JP)

(72) Inventors: Kazuo OSAKA, Musashino-shi, Tokyo (JP); Toshifumi MIYAGI, Musashino-shi, Tokyo (JP)

(73) Assignee: NTT, Inc., Tokyo (JP)

(21) Appl. No.: 19/109,147

(22) PCT Filed: Sep. 9, 2022
(86) PCT No.: PCT/JP2022/033858

§ 371 Date: Mar. 6, 2025

(51) Int. Cl. H04B 7/155; H04L 1/20

(52) U.S. Cl. CPC H04B 7/15564; H04B 7/15528; H04L 1/206

(57) ABSTRACT

The present disclosure relates to a wireless relay device and a wireless relay method for relaying a carrier wave transmitted by a radio signal from an upper-level radio station.

The present disclosure is a wireless relay device that relays a carrier wave transmitted by a radio signal from an upper-level radio station, and is configured to execute modulation system conversion processing of converting a modulation system of the carrier wave into a modulation system having a lower multi-value number; and bandwidth conversion processing of expanding a frequency band of the carrier wave so that transmission capacities of the carrier wave become equal before and after the modulation system conversion processing.

### FIELD

The present disclosure relates to a wireless relay device and a wireless relay method for relaying a carrier wave transmitted by a radio signal from an upper-level radio station.

### BACKGROUND

In a wireless relay device that relays a carrier wave transmitted by a radio signal from an upper-level radio station, an antenna installed on a steel tower and a radio device installed indoors are often distant from each other. Therefore, the loss (Hereinafter, referred to as a feeder line loss.) in the feeder line connecting the two tends to increase. As a countermeasure against the feeder line loss, an amplifier is disposed in a radio device. As a result, the reception signal level attenuated by the feeder line loss can be amplified.

Meanwhile, Non-Patent Literature 1 discloses a method of arranging a low noise amplifier (LNA) as a pre-stage amplifier (preamplifier) in the vicinity of an antenna in a communication receiver. As a result, it is possible to amplify the signal of the weak desired wave to a predetermined reception level.

### CITATION LIST

### Non Patent Literature

Non Patent Literature 1:“Knowledge Base 4 Group 1, Vol. 11, Receiver” (Kenji Ito, The Institute of Electronics, Information and Communication Engineers, IEICE, Ver. 1/2010.11.9)

### SUMMARY

### Technical Problem

However, since the amplifier amplifies not only the power level but also the noise power level of the desired signal included in the carrier wave at the same time, no matter where the amplifier is disposed in the wireless relay device, an effect of improving the C/N (carrier noise ratio) cannot be expected. Therefore, when the feeder line loss is large, there is a problem that the carrier signal does not satisfy the required C/N, and a bit error rate (BER) is deteriorated.

In order to solve the above-described problem, a first object of the present disclosure is to provide a wireless relay device in which even in a case where there is a power loss of the carrier wave due to a feeder line, a carrier wave signal satisfies a required C/N, and BER is not deteriorated.

In addition, a second object of the present disclosure is to provide a wireless relay method in which a carrier wave signal satisfies a required C/N even in a case where there is a power loss of the carrier wave due to a feeder line, and BER is not deteriorated.

### Solution to Problem

A first aspect of the present disclosure is a wireless relay device that relays a carrier wave transmitted by a radio signal from an upper-level radio station, and it is preferable that the wireless relay device is configured to execute:
modulation system conversion processing of converting a modulation system of the carrier wave into a modulation system having a lower multi-value number; and
bandwidth conversion processing of expanding a frequency band of the carrier wave so that transmission capacities of the carrier wave become equal before and after the modulation system conversion processing.

A second aspect of the present disclosure is a wireless relay method for relaying a carrier wave transmitted from an upper-level radio station by a radio signal, and it is preferable that the wireless relay method executes:
modulation system conversion processing of converting a modulation system of the carrier wave into a modulation system having a lower multi-value number; and
bandwidth conversion processing of expanding a frequency band of the carrier wave so that transmission capacities of the carrier wave become equal before and after the modulation system conversion processing.

### Advantageous Effects of Invention

According to the first to second aspects of the present disclosure, it is possible to provide a wireless relay device and a wireless relay method in which even in a case where there is a power loss of the carrier wave due to a feeder line, a carrier wave signal satisfies a required C/N, and BER is not deteriorated.

### BRIEF DESCRIPTION OF DRAWINGS

FIG. 1 is a schematic diagram illustrating a conventional wireless relay device and a modulation system of a carrier wave received by the wireless relay device according to a comparative example of the present disclosure.

FIG. 2 is a schematic diagram illustrating a conventional wireless relay device including an LNA as a pre-stage amplifier and a modulation system of a carrier wave received by the wireless relay device according to a comparative example of the present disclosure.

FIG. 3 is a schematic diagram illustrating a configuration example of an upper station, a wireless relay device, and a lower station and a modulation system of a carrier wave relayed by the wireless relay device according to a comparative example of the present disclosure.

FIG. 4 is a schematic diagram illustrating a functional configuration example of a conventional wireless relay device according to a comparative example of the present disclosure.

FIG. 5 is a schematic diagram illustrating a wireless relay device and a modulation system of a carrier wave received by the wireless relay device according to a first embodiment of the present disclosure.

FIG. 6 is a diagram illustrating a functional configuration example of the wireless relay device according to the first embodiment of the present disclosure.

FIG. 7 is a schematic diagram illustrating a wireless relay device including an LNA and a modulation system of a carrier wave according to a second embodiment of the present disclosure.

FIG. 8 is a diagram illustrating a functional configuration example of the wireless relay device according to the second embodiment of the disclosure.

FIG. 9 is a schematic diagram illustrating a configuration example of an upper station, a wireless relay device, and a lower station and a modulation system of a carrier wave relayed by the wireless relay device according to a third embodiment of the present disclosure.

FIG. 10 is a diagram illustrating a functional configuration example of a transmission device that performs radio communication with a wireless relay device.

FIG. 11 is a schematic diagram illustrating a functional configuration example of a wireless relay device according to the third embodiment of the present disclosure.

FIG. 12 is a schematic diagram illustrating a configuration example of an upper station, a wireless relay device, and a lower station and a modulation system of a carrier wave relayed by the wireless relay device according to a fourth embodiment of the present disclosure.

FIG. 13 is a flowchart of processing performed by the wireless relay device according to the fourth embodiment of the present disclosure.

### DESCRIPTION OF EMBODIMENTS

### Comparative Example

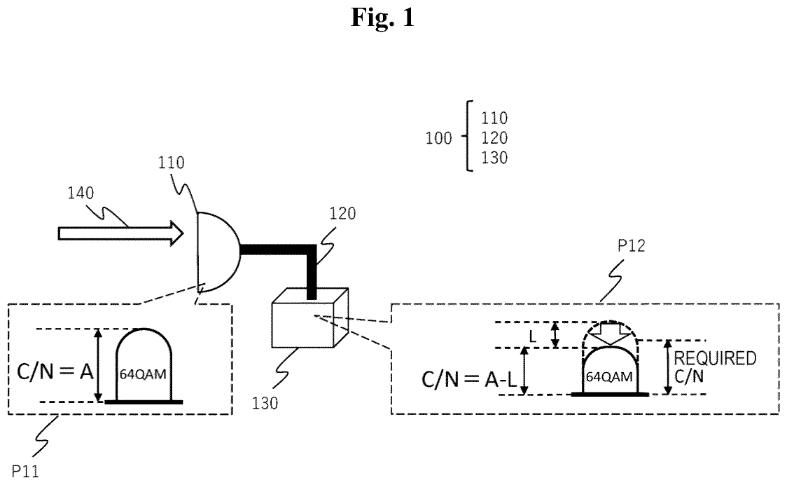

Here, first, a comparative example will be described. FIG. 1 is a schematic diagram illustrating a conventional wireless relay device and a modulation system of a carrier wave received by the wireless relay device according to a comparative example of the present disclosure.

In FIG. 1, a wireless relay device 100 relays a carrier wave 140 transmitted by a radio signal from an upper-level radio station (Hereinafter, referred to as an upper station.). An antenna 110 of the wireless relay device 100 receives the carrier wave 140 transmitted from the upper station and reaching itself. The carrier wave 140 received by the antenna 110 is transmitted to a radio device 130 through a feeder line 120.

The radio device 130 is a receiver that performs demodulation, error correction encoding, and the like on the carrier wave 140 received by the antenna 110 and transmitted via the feeder line 120. Further, the radio device 130 transmits the demodulated and error-correction-encoded signal to a terminal.

The carrier wave 140 occupies a frequency band within a certain range, but it is assumed that the occupied frequency band is not limited. The modulation system of the carrier wave 140 is, for example, 64 quadrature amplitude modulation (QAM). Here, a panel P11 of FIG. 1 illustrates frequency characteristics of the power of the carrier wave 140 at the time of antenna reception. Further, C/N of the carrier wave here is A.

Although only one carrier wave 140 is illustrated in the panel P11, the radio transmission method may be multi-carrier transmission including a plurality of carrier waves 140. Alternatively, single carrier transmission including only one carrier wave 140 as in the panel P11 may be used. This point is assumed to be common to the following comparative examples and embodiments.

When the carrier wave 140 passes through the feeder line 120, a feeder line loss L occurs. A panel P12 of FIG. 1 illustrates frequency characteristics of the power of the carrier wave 140 after passing through the feeder line 120. After passing through the feeder line 120, the power of the carrier wave 140 decreases by the feeder line loss L. Therefore, C/N after passing through the feeder line 120 is expressed as (C/N=A−L).

Here, in the radio communication, C/N at which BER is a specified value is calculated for each modulation system. For example, in the case of 64 QAM, a required C/N is 24.2 dB. When a C/N of the carrier wave 140 input to the radio device 130 does not satisfy the required C/N, BER degradation occurs.

Therefore, at the time of reception of the antenna 110, even if the C/N (=A) is equal to or greater than the required C/N (panel P11), the feeder line loss L is large, and when the C/N (=A−L) after passing through the feeder line 120 falls below the required C/N (panel P12), BER degradation occurs.

Note that, in the prior art, an amplifier is disposed in the radio device 130. However, even if a signal of the carrier wave 140 (panel P12) after passing through the feeder line 120 is amplified, the amplifier itself does not have an effect of improving C/N, so that BER degradation cannot be avoided.

As described above, in the wireless relay device 100 of the prior art, BER degradation due to the feeder line loss of the carrier wave 140 cannot be avoided.

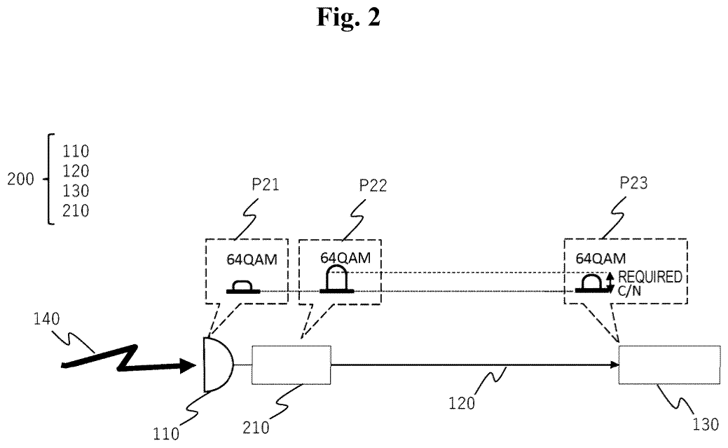

FIG. 2 is a schematic diagram illustrating a conventional wireless relay device including an LNA as a pre-stage amplifier and a modulation system of a carrier wave received by the wireless relay device according to a comparative example of the present disclosure. A wireless relay device 200 is similar to the wireless relay device 100 in FIG. 1, but an LNA 210 having good internal noise characteristics is installed as a pre-stage amplifier immediately near the antenna 110. The LNA 210 is used when the antenna 110 receives a weak radio wave in satellite communication or the like.

In FIG. 2, panels P21 and P22 illustrate frequency characteristics of the power of the carrier wave 140 at the time of reception of the antenna 110 and after amplification of the LNA 210, respectively. A signal of a weak carrier wave at the time of reception of the antenna 110 is amplified by the LNA 210. As described above, by amplifying the signal of the carrier wave 140 immediately near the antenna 110, it is possible to avoid amplifying even noise power generated in the feeder line 120.

However, even if the pre-stage amplifier is installed immediately near the antenna 110 as illustrated in FIG. 2, the amplifier itself does not have an effect of improving the C/N, and thus when a large feeder line loss L occurs, the C/N deteriorates. Therefore, also in this case, similarly to FIG. 1, the carrier wave 140 input to the radio device 130 does not satisfy the required C/N, and BER deterioration cannot be avoided (panel P23 in FIG. 2).

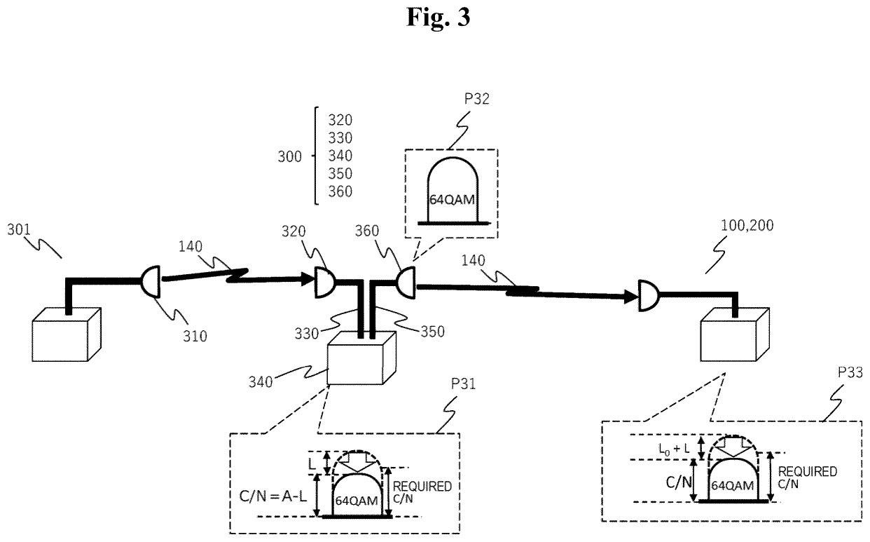

FIG. 3 is a schematic diagram illustrating a configuration example of an upper station, a wireless relay device, and a lower-level radio station (Hereinafter, referred to as a lower station.) and a modulation system of a carrier wave relayed by the wireless relay device according to a comparative example of the present disclosure.

A wireless relay device 300 relays between upper-level and lower-level radio stations. The wireless relay device 300 receives the carrier wave 140 transmitted from an antenna 310 of a transmission device 301, which is an upper station, by a reception antenna 320. Further, it is transmitted to a radio device 340 via a feeder line 330. The radio device 340 amplifies the received carrier wave 140, demodulates the carrier wave once, and then modulates the carrier wave again. Further, the re-modulated carrier wave 140 is transmitted to a transmission antenna 360 via a feeder line 350.

The lower station is the wireless relay device 100, 200 that receives the carrier wave 140 transmitted from the wireless relay device 300. Since the function of the wireless relay device 100, 200 is similar to that described with reference to FIGS. 1 and 2, the description thereof will be omitted.

In FIG. 3, a panel P31 indicates the power frequency characteristic of the carrier wave 140 after passing through the feeder line 330. Similarly to the panel P11 of FIG. 1, the C/N of the carrier wave is decreased by the feeder line loss L. Further, a panel P32 is a frequency characteristic of the power of the carrier wave 140 in the transmission antenna 360. Here, the C/N is also decreased by the feeder line 350.

Furthermore, the carrier wave 140 transmitted from the transmission antenna 360 is affected by fading while propagating through a radio section. Therefore, the power of the carrier wave 140 in the radio device 130 of the wireless relay device 100, 200 that has received the carrier wave 140 is reduced not only by the feeder line loss L due to the feeder line 120 but also by the propagation loss Lo of the carrier wave 140 in the radio section (panel P33).

Therefore, in the transmission antenna 360 of the wireless relay device 300, even if the C/N of the carrier wave 140 is equal to or greater than the required C/N (panel P32), when the propagation loss Lo is large, the required C/N cannot be satisfied in the wireless relay device 100, 200 (panel P33). Therefore, BER degradation occurs. Since the propagation loss Lo increases as the radio section is longer, the effect of BER degradation is particularly remarkable when the wireless relay device 300 and the wireless relay device 100, 200 are separated from each other.

In FIG. 3, a case where the upper station is the transmission device 301 has been described. However, the upper station only needs to be a radio station having a radio transmission function, and may be, for example, a radio base station, a wireless relay station, or the like. Similarly, the lower station may not be the wireless relay device 100, 200, and may be a radio station having a radio reception function, for example, a radio base station, a wireless relay station, or the like. This point is also common in the following comparative examples and embodiments.

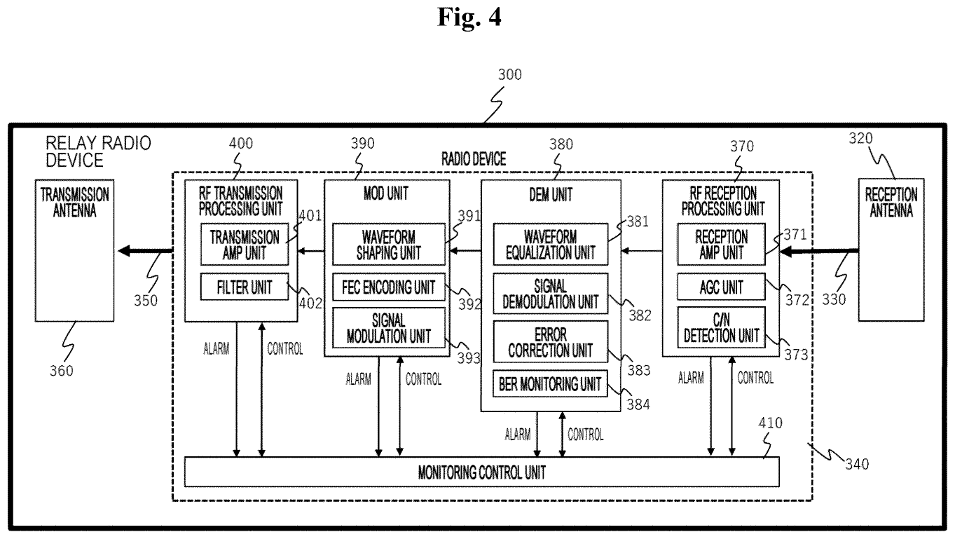

FIG. 4 is a schematic diagram illustrating a functional configuration example of a conventional wireless relay device according to a comparative example of the present disclosure. In FIG. 4, the reception antenna 320 transmits the received carrier wave 140 to the radio device 340 via the feeder line 330. The radio device 340 demodulates, error-corrects, and re-modulates the received carrier wave 140. The radio device 340 includes an RF reception processing unit 370, a DEM unit 380, a MOD unit 390, an RF transmission processing unit 400, and a monitoring control unit 410.

The RF reception processing unit 370 is a unit that processes a radio frequency (RF) signal input from the reception antenna 320. The RF reception processing unit 370 includes a reception AMP unit 371, an automatic gain control (AGC) unit 372, and a C/N detection unit 373. The reception AMP unit 371 is a unit that amplifies the received radio frequency. The AGC unit 372 is a unit that automatically corrects the reception gain depending on the level of the reception signal. The C/N detection unit 373 is a unit that detects the C/N of the input carrier wave 140.

The DEM unit 380 is a unit that performs demodulation, error correction, and monitoring control of BER on the signal input from the RF reception processing unit 370. The DEM unit 380 includes a waveform equalization unit 381, a signal demodulation unit 382, an error correction unit 383, and a BER monitoring unit 384.

The waveform equalization unit 381 is a unit that equalizes the waveform of the reception signal to a desired waveform. The signal demodulation unit 382 is a unit that demodulates the waveform of the reception signal. The error correction unit 383 is a unit that performs error correction decoding. The BER monitoring unit 384 is a unit that monitors whether or not BER degradation occurs on the basis of the modulation system of the input carrier wave.

The MOD unit 390 is a unit that re-modulates the signal input from the DEM unit 380. The MOD unit 390 includes a waveform shaping unit 391, a forward error correction (FEC) encoding unit 392, and a signal modulation unit 393. The waveform shaping unit 391 is a unit that shapes a waveform of a signal. The FEC encoding unit 392 is a unit that adds a code for error correction to a signal. The signal modulation unit 393 is a unit that performs re-modulation.

The RF transmission processing unit 400 is a unit that performs transmission processing on the transmission signal input from the MOD unit 390. The RF transmission processing unit 400 includes a transmission AMP unit 401 and a filter unit 402. The transmission AMP unit 401 amplifies the transmission signal. The filter unit 402 removes unnecessary frequency components from the transmission signal.

The monitoring control unit 410 monitors the RF reception processing unit 370, the DEM unit 380, the MOD unit 390, and the RF transmission processing unit 400. In addition, it is a unit that receives an alarm and performs control when predetermined processing cannot be executed in each unit. Furthermore, it controls each unit even in a case where interference of power with another radio station or the like becomes a problem and it is necessary to urgently stop the processing of the own station.

The transmission antenna 360 transmits the carrier wave 140 transmitted from the RF transmission processing unit 400 via the feeder line 350 to the lower station as a radio signal.

As described above, the conventional wireless relay device 300 once demodulates the received carrier wave 140, re-modulates it, and then transmits it to the lower station. A large radio device 340 is required for demodulation and re-modulation, and the radio device 340 has to be installed indoors due to problems such as maintenance. Therefore, the distance between the antenna and the radio device 340 is large, and a large feeder line loss occurs in the feeder line 330, 350 connecting the antenna and the radio device.

As described above with reference to FIGS. 1 to 4, in the wireless relay device 100, 200, 300 of the prior art, when the feeder line loss and the propagation loss are large, the C/N of the carrier wave does not satisfy the required C/N, and BER degradation occurs.

### First Embodiment

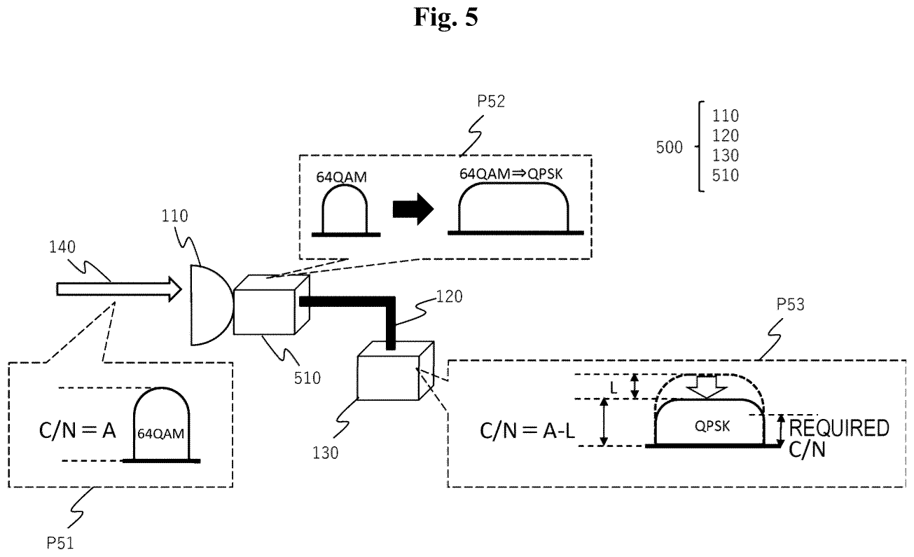

FIG. 5 is a schematic diagram illustrating a wireless relay device and a modulation system of a carrier wave received by the wireless relay device according to the first embodiment of the present disclosure. A wireless relay device 500 further includes a modulation conversion device 510 immediately after the antenna 110 in the configuration example of the wireless relay device 100 of FIG. 1 described as a comparative example.

The modulation conversion device 510 converts the modulation system of the carrier wave 140 received by the antenna 110 from 64 QAM to QPSK (Quarter Phase Shift Keying) having a lower multi-value number. Here, 64 QAM can carry 6 bits of information by one-time modulation (per symbol) using a 64-value symbol, but QPSK can carry only 2 bits using 4 values. Therefore, the modulation conversion device 510 expands the frequency band of the carrier wave 140 to 3 times, and secures the same transmission capacity as that before conversion even after conversion into QPSK (panel P52 in FIG. 5).

Furthermore, the modulation conversion device 510 transmits the carrier wave 140 obtained by performing modulation and conversion and expanding the frequency band to the radio device 130 via the feeder line 120. Since there is no limitation by the radio law in the waveguide and the coaxial cable constituting the feeder line 120, the modulation system and the bandwidth can be freely set.

Here, in the reception of the radio signal, the C/N necessary for the reception signal to satisfy the prescribed BER is calculated as the required C/N. The required C/N decreases as the modulation system has a lower multi-value number. For QPSK, the required C/N is 11.2 dB, which is lower than the required C/N of 64 QAM (=24.2 dB).

In the present disclosure, the modulation conversion device 510 converts the modulation system into a modulation system having a low multi-value number, thereby lowering the required C/N in the radio device 130. A degradation margin of 13 dB or more can be provided in the C/N of the carrier wave 140 by the amount by which the required C/N is lowered. This makes it possible to produce an effect of improving the BER.

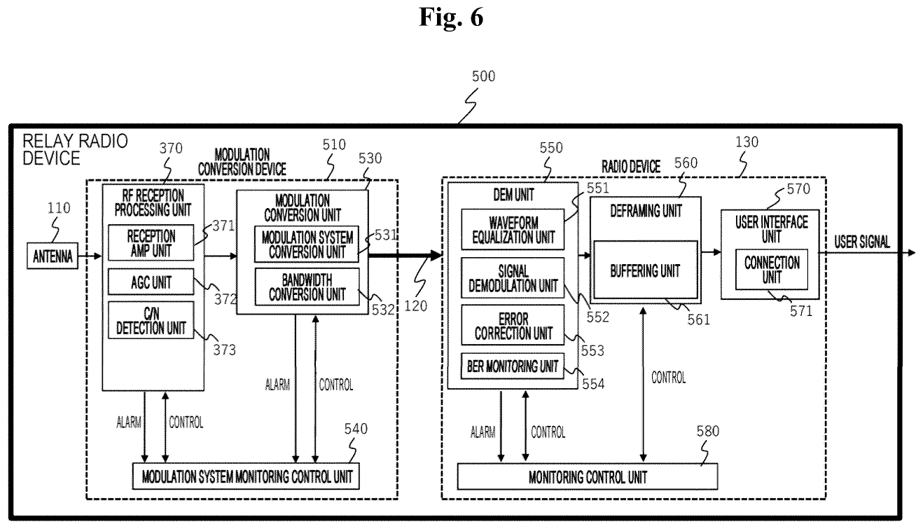

FIG. 6 is a diagram illustrating a functional configuration example of the wireless relay device according to the first embodiment of the present disclosure. The antenna 110 transmits the received carrier wave 140 to the modulation conversion device 510. The RF reception processing unit 370 in the modulation conversion device 510 is similar to the RF reception processing unit 370 in the prior art of FIG. 4, and thus description thereof is omitted.

The modulation conversion unit 530 is a unit that performs modulation conversion and frequency bandwidth change on the RF signal amplified by the RF reception processing unit 370. The modulation conversion unit 530 includes a modulation system conversion unit 531 and a bandwidth conversion unit 532. The modulation conversion unit 530 is a unit that performs conversion from 64 QAM to QPSK for the carrier wave 140. The bandwidth conversion unit 532 is a unit that expands the frequency bandwidth to 3 times.

The modulation system monitoring control unit 540 is a unit that monitors the RF reception processing unit 370 and the modulation conversion unit 530. In addition, it is a unit that receives an alarm and performs control in a case where predetermined processing cannot be executed in each unit to be monitored.

The radio device 130 is a device that demodulates the carrier wave modulated and converted by the modulation conversion device 510 and input via the feeder line 120 and transmits a user signal to the terminal. The DEM unit 550 in the radio device 130 is similar to the DEM unit 380 in the prior art. However, in the BER monitoring unit 554, BER degradation is monitored based on a required C/N (=11.2 dB) of QPSK.

The deframing unit 560 includes a buffering unit 561 that temporarily buffers a transmission/reception signal. The user interface unit 570 includes a connection unit 571 that transmits a user signal to the terminal.

The monitoring control unit 580 is a unit that performs monitoring control of the DEM unit 550 and the deframing unit 560. In addition, it is a unit that receives an alarm and performs control in a case where predetermined processing cannot be executed in the DEM unit 550.

In this manner, the wireless relay device 500 performs modulation conversion and bandwidth expansion in the modulation conversion device 510. The carrier wave 140 converted from 64 QAM to QPSK is demodulated in the radio device 130, and BER degradation is monitored based on a required C/N (=11.2 dB) of QPSK.

As described above, in the wireless relay device 500 of the present embodiment, the modulation conversion device 510 installed immediately after reception of the antenna 110 converts the carrier wave 140 into a modulation system having a lower multi-value number and expands the bandwidth. As a result, it is possible to lower the required C/N while securing the transmission capacity of the carrier wave 140 and to produce an effect of improving the BER.

Either the processing performed by the modulation system conversion unit 531 or the processing performed by the bandwidth conversion unit 532 described in the present embodiment may be performed first. This point is also common to the following embodiments.

### Second Embodiment

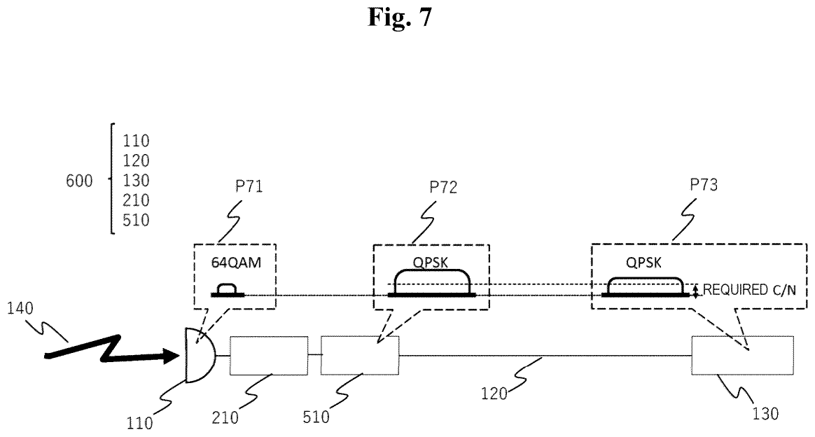

FIG. 7 is a schematic diagram illustrating a modulation system of a wireless relay device including an LNA and a carrier wave according to the second embodiment of the present disclosure. A wireless relay device 600 is similar to the wireless relay device 500 in FIG. 5, but further includes an LNA 210. The LNA 210 is placed immediately near the antenna 110, and pre-stage amplifies a weak carrier signal.

In this way, by further adding the LNA 210, it is possible to pre-stage amplify the weak carrier signal in addition to the effects of the first embodiment.

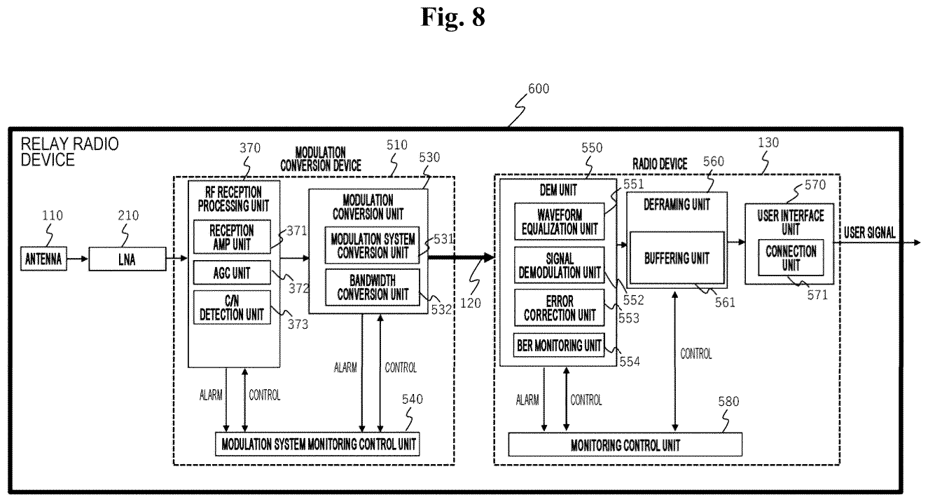

FIG. 8 is a diagram illustrating a functional configuration example of a wireless relay device according to a second embodiment of the present disclosure. In the wireless relay device 600 of FIG. 8, the LNA 210 is added immediately near the antenna 110 in addition to the functional configuration example of FIG. 6.

As described above, the wireless relay device 600 according to the present embodiment can have a pre-stage-amplification function by the LNA 210.

### Third Embodiment

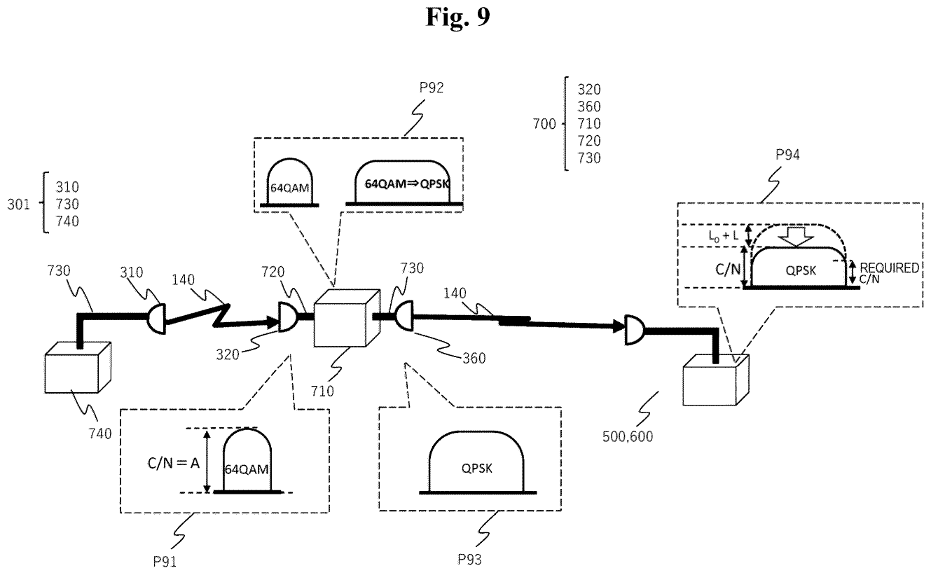

FIG. 9 is a schematic diagram illustrating a configuration example of an upper station, a wireless relay device, and a lower station and a modulation system of a carrier wave relayed by the wireless relay device according to the third embodiment of the present disclosure.

The wireless relay device 700 includes a reception antenna 320, a transmission antenna 360, and a radio device 710, similarly to the conventional wireless relay device 300 of FIG. 3 described as a comparative example. The radio device 710 includes the modulation conversion unit 530.

The carrier wave received by the reception antenna 320 of the wireless relay device 700 is transmitted to the radio device 710 via a feeder line 720. The radio device 710 performs modulation conversion and frequency band change of the received carrier wave 140. Further, the re-modulated carrier wave 140 is transmitted to the transmission antenna 360 via a feeder line 730.

Note that, in FIG. 9, details of the transmission device 301 as an upper station will be described later. Further, since the wireless relay device 500, 600 which is a lower station is similar to that in FIGS. 5 and 7, the description thereof is omitted.

A panel P91 of FIG. 9 illustrates frequency characteristics of power of the carrier wave 140 in the reception antenna 320. Here, the carrier wave modulated by the 64 QAM system is received. In addition, a panel P92 is modulated and converted from 64 QAM to QPSK in the radio device 710, and the frequency band is expanded to 3 times. The carrier wave 140 modulated by the QPSK system is transmitted from the transmission antenna 360 (panel P93).

The power loss of the carrier wave 140 in the radio device 130 of the wireless relay device 500, 600 includes the feeder line loss L and the propagation loss Lo due to the feeder line 120 (panel P94), similarly to the description in FIG. 3. However, as described in the first and second embodiments, since the modulation system is changed to QPSK, the required C/N decreases, and there is a degradation margin of 13 dB or more in the C/N of the carrier wave 140. As a result, even when a large propagation loss Lo occurs in the radio section, it is possible to produce an effect of improving BER degradation.

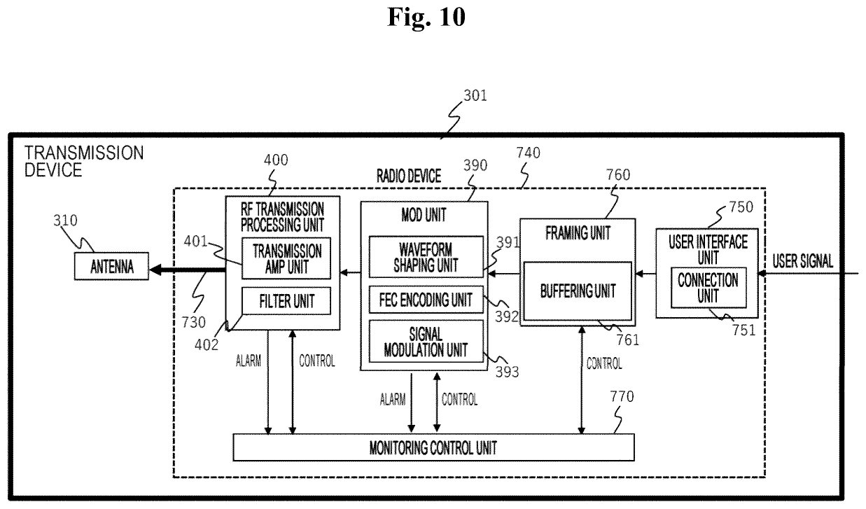

FIG. 10 is a diagram illustrating a functional configuration example of a transmission device that performs radio communication with a wireless relay device. The transmission device 301 which is an upper station includes an antenna 310 and a radio device 740.

A user interface unit 750 of the radio device 740 includes a connection unit 751 that receives the user signal transmitted from the terminal. A framing unit 760 includes a buffering unit 761 that temporarily stores the signal transmitted from the user interface unit 750. In addition, the functions of the MOD unit 390 and the RF transmission processing unit 400 are the same as the functions described in FIG. 4, and thus, description thereof is omitted.

A monitoring control unit 770 is a unit that performs monitoring control of the framing unit 760, the MOD unit 390, and the RF transmission processing unit 400. In addition, it is a unit that receives an alarm and performs control in a case where the MOD unit 390 and the RF transmission processing unit 400 cannot execute predetermined processing. Furthermore, it controls each unit even in a case where interference of power with another radio station or the like becomes a problem and it is necessary to urgently stop the processing of the own station.

The transmission antenna 360 transmits the carrier wave 140 transmitted from the RF transmission processing unit 400 via the feeder line 730 to the wireless relay device 700.

As described above, the transmission device 301 of the present embodiment receives the user signal, performs encoding and modulation, and then transmits the carrier wave 140 from the transmission antenna.

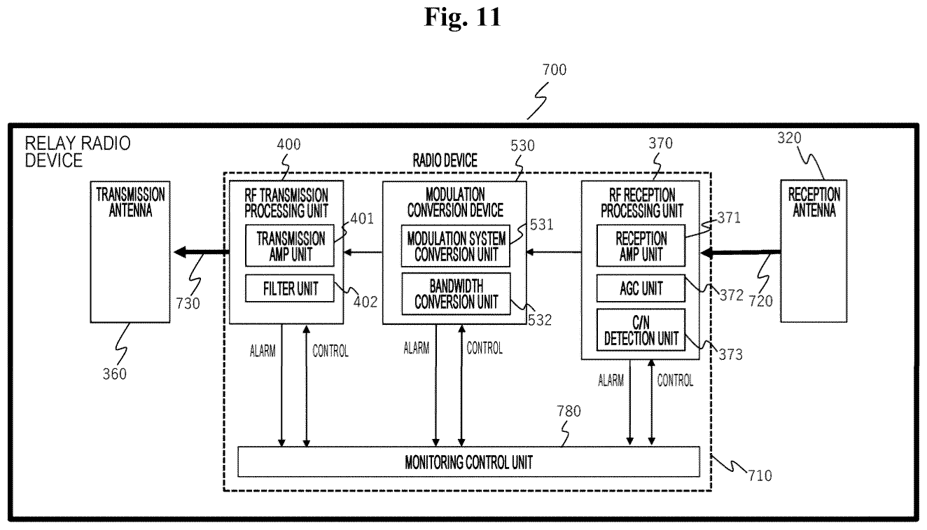

FIG. 11 is a schematic diagram illustrating a functional configuration example of a wireless relay device according to the third embodiment of the present disclosure. The wireless relay device 700 includes a reception antenna 320, a transmission antenna 360, and a radio device 710, similarly to the conventional wireless relay device 300 of FIG. 4 described as a comparative example. The radio device 710 includes an RF reception processing unit 370, a modulation conversion unit 530, an RF transmission processing unit 400, and a monitoring control unit 780. Since the functions of the RF reception processing unit 370 and the RF transmission processing unit 400 are similar to those in FIG. 4, the description thereof will be omitted. In addition, since the function of the modulation conversion unit 530 is similar to that of FIG. 6, the description thereof is omitted.

The monitoring control unit 780 is a unit that performs monitoring control of the RF reception processing unit 370, the modulation conversion unit 530, and the RF transmission processing unit 400. In addition, it is a unit that receives an alarm and performs control in a case where predetermined processing cannot be executed in each unit. Furthermore, it controls each unit even in a case where interference of power with another radio station or the like becomes a problem and it is necessary to urgently stop the processing of the own station.

As described above, in the wireless relay device 700 of the present embodiment, the received carrier wave 140 is converted into a modulation system having a lower multi-value number, and the frequency bandwidth is expanded. As a result, it is possible to reduce the required C/N and produce an effect of improving the BER while securing the transmission capacity of the carrier wave 140 transmitted as a radio signal from the wireless relay device 700 to the lower station.

In addition, since the wireless relay device 700 in the present embodiment does not need to perform demodulation and re-modulation unlike the wireless relay device 300 of the prior art, it is possible to provide the radio device 710 that is smaller than the prior art.

The miniaturization of the radio device 710 creates a new advantage that the radio device 710 that has to be installed indoors in the prior art can be installed outdoors. That is, the distances between the reception antenna 320 and the transmission antenna 360 and the radio device 710 can be shortened, and the feeder line 720, 730 connecting them can also be shortened. As a result, an effect that the feeder line loss can be suppressed is produced.

### Modification

In the wireless relay device 700, the LNA 210 may be arranged immediately near the reception antenna 320 to have a pre-stage-amplification function.

### Fourth Embodiment

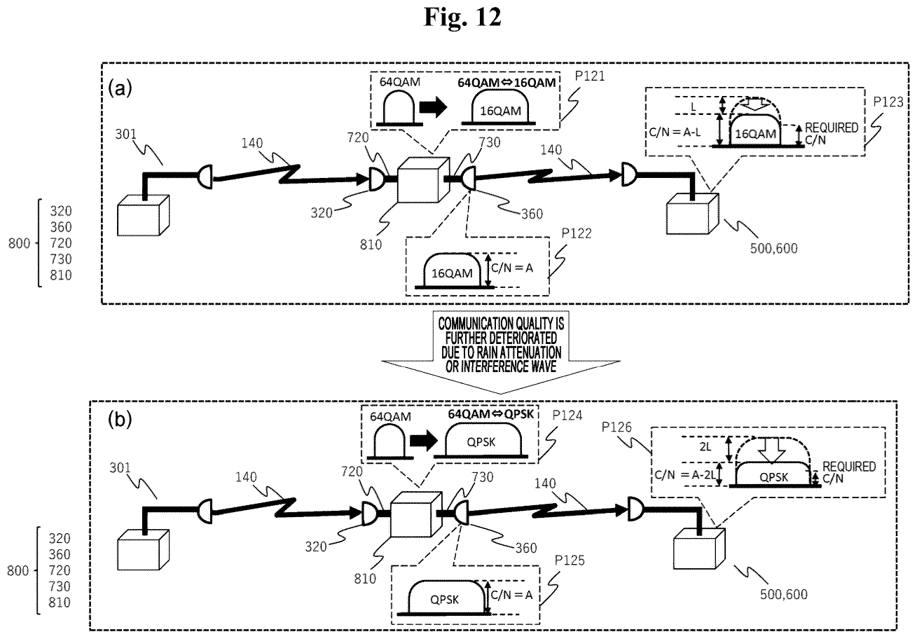

FIG. 12 is a schematic diagram illustrating a configuration example of an upper station, a wireless relay device, and a lower station and a modulation system of a carrier wave relayed by the wireless relay device according to the fourth embodiment of the present disclosure.

Similarly to the wireless relay device 700 of the third embodiment, a wireless relay device 800 includes a reception antenna 320, a transmission antenna 360, and a radio device 810. The radio device 810 includes a modulation conversion unit 530.

In the wireless relay device 800 of FIG. 12, the radio device 810 detects a temporal change in the propagation environment of the carrier wave 140 by detecting a temporal change in the communication quality of the radio communication. As the communication quality, for example, the C/N of the reception signal received by the reception antenna 320 is used. Further, the radio device 810 converts the modulation system depending on the communication quality. In addition, with the modulation conversion, the frequency band is expanded or reduced to secure the transmission capacity of the carrier wave 140.

FIG. 12(a) illustrates functions of the wireless relay device 800 in a case where the communication quality is deteriorated. In this case, the radio device 810 of the wireless relay device 800 converts the modulation system of the carrier wave 140 from current 64 QAM to 16 QAM having a lower multi-value number. Furthermore, the frequency bandwidth is expanded, and the same transmission capacity as that before conversion is secured for the carrier wave after modulation conversion (panel P121).

Here, in the case of 16 QAM, the required C/N is 18.1 dB, which is lower than the required C/N of 64 QAM (=24.2 dB). Therefore, a C/N degradation margin of 6.1 dB can be provided for the carrier wave 140 received by the wireless relay device 500, 600 which is a lower station.

On the other hand, FIG. 12(b) illustrates functions of the wireless relay device 800 in a case where the communication quality is further deteriorated due to rain attenuation or an interference wave as compared with the case of the radio communication in (a). In this case, the radio device 810 converts the modulation system of the carrier wave 140 into QPSK having a lower multi-value number than current 16 QAM. Further, the bandwidth is expanded to secure the transmission capacity (panel P124).

By further converting the modulation system to a lower order, it is possible to further provide a C/N degradation margin in the wireless relay device 500, 600 which is a lower station. Therefore, for example, even if the propagation loss from the wireless relay device 800 to the lower station is deteriorated to twice the case in (a), the effect of improving the BER degradation by the margin can be produced (panel P126).

As described above, the wireless relay device 800 according to the present embodiment performs modulation conversion and expansion or reduction of a frequency band depending on communication quality. Here, conventionally, a technique of adaptively modulating a modulation system depending on communication quality has been used, but since a bandwidth is fixed, a transmission capacity fluctuates with modulation conversion. In this regard, in the present disclosure, it is possible to relay to the lower station while maintaining the transmission capacity in the upper station.

Here, the wireless relay device 800 of the present embodiment is particularly suitable for medical, aviation, and military applications. As described above, with the conventional technique, transmission capacity fluctuates with adaptive modulation. This is because, while the fluctuation does not cause a problem in best effort type data communication such as IP (Internet Protocol) communication, the fluctuation causes a problem in medical, aviation, and military applications in which transmission capacity needs to be guaranteed.

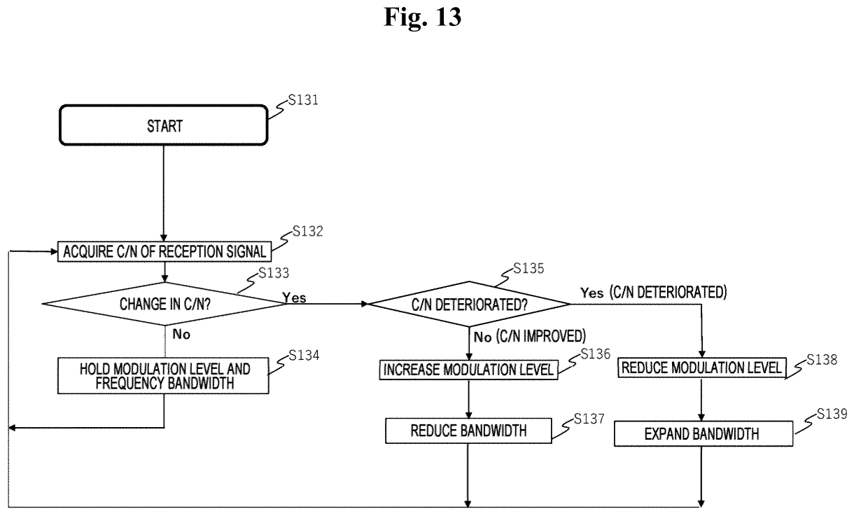

FIG. 13 is a flowchart of processing performed by the wireless relay device according to the fourth embodiment of the present disclosure. First, the wireless relay device 800 starts processing (step S131). Next, the C/N of the signal received by the reception antenna is acquired (step S132). Next, the acquired C/N is compared with the C/N at the time of previous acquisition, and processing of determining whether or not there is a change is performed (step S133). When it is determined that there is no change in C/N, it means that there is no change in the propagation environment of the carrier wave 140. Therefore, the modulation level and the frequency bandwidth are held (step S134). After step S134 is processed, the process proceeds to step S132 to continue the communication.

On the other hand, in a case where it is determined in step S133 that there is a change in C/N, processing of determining whether or not the C/N is deteriorated is further performed (step S135). The case where the C/N is not deteriorated means that the C/N is improved and the propagation environment is improved. Therefore, in this case, the modulation system conversion unit 531 in the modulation conversion unit 530 performs processing of increasing the modulation level (step S136). Furthermore, the bandwidth conversion unit 532 performs processing of reducing the frequency bandwidth (step S137). After step S137 is processed, the process proceeds to step S132 to continue the communication.

On the other hand, the case where the C/N is deteriorated in step S135 means that the propagation environment is deteriorated. Therefore, in this case, the modulation system conversion unit 531 performs processing of reducing the modulation level (step S138). Further, the bandwidth conversion unit 532 performs processing of expanding the frequency bandwidth (step S139). After step S139 is processed, the process proceeds to step S132 to continue the communication.

As described above with reference to the flowchart, the wireless relay device 800 according to the present embodiment detects a temporal change in C/N and continues the processing of controlling the modulation level and the bandwidth depending on the temporal change. As a result, it is possible not only to adaptively control the modulation system depending on the time variation of the communication quality as in the prior art, but also to relay to the lower station while maintaining the transmission capacity in the upper station.

As described above, according to the present disclosure, it is possible to provide a wireless relay device and a wireless relay method that satisfy the required C/N and do not degrade the BER of a reception signal even when there is a power loss of a carrier wave due to a feeder line.

### Modification

In the first to third embodiments of the present disclosure, it has been described that the wireless relay device 500, 600, 700 includes the modulation conversion unit 530 and performs modulation and conversion from 64 QAM to QPSK. However, the modulation system described herein is an example, and does not limit the technical scope of the present disclosure. The processing performed by the modulation conversion unit 530 included in the wireless relay device 500, 600, 700 need only be conversion to a modulation system having a lower multi-value number, and a suitable modulation system can be selected depending on the use environment.

Similarly, in the fourth embodiment of the present disclosure, it has been described that the wireless relay device 800 includes the modulation conversion unit 530 and performs modulation and conversion depending on a temporal change in communication quality. However, the modulation system may be a modulation system different from that exemplified in the fourth embodiment, and a suitable modulation system may be selected depending on the communication quality.

In the fourth embodiment of the present disclosure, it has been described that the wireless relay device 800 detects a temporal change in C/N. However, a temporal change in another communication quality may be detected. For example, the signal-to-interference-plus-noise power ratio C/(N+I) may be used. Here, I is the interference power. Furthermore, it is also possible to detect a temporal change by monitoring a BER or a rainfall amount in a transmission path. In particular, in a radio wave having a frequency of 10 GHz or more, the influence of attenuation of rainfall is large, and thus monitoring of rainfall is effective. In addition, it is also possible to detect a temporal change using an ACK frame or a NACK frame.

In addition, the communication quality may not be measured by the wireless relay device 800. For example, the communication quality may be measured in the upper station or the lower station and notified to the wireless relay device 800.

The present disclosure is applicable not only to a microwave band but also to any frequency band. In addition, the present invention is not limited to the application of fixed microwave relay, and can be applied to mobile backhaul, radio access, wireless LAN, simple radio, weak radio, drone control, and the like.

In the present disclosure, the processing performed by the wireless relay device 500, 600, 700, 800 may be executed by a program using a computer including a CPU and a memory and storing the program in the memory. Alternatively, the program may be executed using an integrated circuit such as a field programmable gate array (FPGA). Note that the program may be provided by being recorded in a storage medium, or may be provided through a network.

### Correspondence With Terms Described in Claims

The processing performed by the modulation system conversion unit 531 included in the wireless relay device 500, 600, 700 described in the first to third embodiments of the present disclosure is referred to as modulation system conversion processing. Furthermore, the processing performed by the bandwidth conversion unit 532 is referred to as bandwidth conversion processing.

In addition, the processing performed by the signal demodulation unit 552 and the error correction unit 553 included in the wireless relay device 500, 600 described in the first and second embodiments of the present disclosure is referred to as demodulation/decoding processing.

Further, the processing performed by the modulation system conversion unit 531 when the wireless relay device 800 detects improvement in communication quality described in the fourth embodiment of the present disclosure is referred to as multi-value number increasing processing. The multi-value number increasing processing is the processing of step S136.

### REFERENCE SIGNS LIST

100, 200, 300, 500, 600, 700, 800 wireless relay device
110, 310 antenna
120, 330, 350, 720, 730 feeder line
130, 340, 710, 740, 810 radio device
140 carrier wave
210 LNA
301 transmission device
320 reception antenna
360 transmission antenna
370 RF reception processing unit
371 reception AMP unit
372 AGC circuit
373 C/N detection unit
380, 550 DEM unit
381, 551 waveform equalization unit
382, 552 signal demodulation unit
383, 553 error correction unit
384, 554 BER monitoring unit
390 MOD unit
391 waveform shaping unit
392 FEC encoding unit
393 signal modulation unit
400 RF transmission processing unit
401 transmission AMP unit
402 filter unit
410, 580, 770, 780 monitoring control unit
510 modulation conversion device
530 modulation conversion unit
531 modulation system conversion unit
532 bandwidth conversion unit
540 modulation system monitoring control unit
560 deframing unit
561, 761 buffering unit
570, 750 user interface unit
571, 751 connection unit
760 framing unit

1. A wireless relay device that relays a carrier wave transmitted by a radio signal from an upper-level radio station, the wireless relay device being configured to execute:
converting a modulation system of the carrier wave into a modulation system having a lower multi-value number; and
expanding a frequency band of the carrier wave so that transmission capacities of the carrier wave become equal before and after the modulation system conversion

2. The wireless relay device according to claim 1, further comprising a transceiver,
the transceiver being configured to execute:
demodulating and error-correcting a carrier wave processed in the modulation system conversion and the bandwidth conversion; and
transmitting the signal processed in the demodulation/decoding to a terminal.

3. The wireless relay device according to claim 1, further comprising transmitting the carrier wave processed in the modulation system conversion and the bandwidth conversion to a lower-level radio station by a radio signal.

4. The wireless relay device according to claim 1, further comprising a low noise amplifier, wherein
the low noise amplifier performs pre-stage amplification of a carrier wave signal transmitted from the upper-level radio station.

5.-8. (canceled)

9. The wireless relay device according to claim 2, further comprising a low noise amplifier, wherein
the low noise amplifier performs pre-stage amplification of a carrier wave signal transmitted from the upper-level radio station.

10. The wireless relay device according to claim 3, wherein
the wireless relay device further executes detecting a temporal change in communication quality of a radio communication performed by the own device,
when the communication quality is improved, the wireless relay device executes:
converting a modulation system of a carrier wave transmitted from the upper-level radio station into a modulation system having a higher multi-value number; and
reducing a frequency band of the carrier wave so that transmission capacities of the carrier wave become equal before and after the multi-value number increasing, and
when the communication quality is deteriorated, the wireless relay device executes:
the modulation system conversion; and
the bandwidth conversion.

11. A wireless relay method for relaying a carrier wave transmitted from an upper-level radio station by a radio signal, the wireless relay method comprising:
a modulation system of the carrier wave into a modulation system having a lower multi-value number; and
expanding a frequency band of the carrier wave so that transmission capacities of the carrier wave become equal before and after the modulation system conversion.

12. The wireless relay method according to claim 11, further comprising:
demodulating and error-correcting a carrier wave processed in the modulation system conversion and the bandwidth conversion; and
transmitting the signal processed in the demodulation/decoding to a terminal.

13. The wireless relay method according to claim 11, further comprising transmitting the carrier wave processed in the modulation system conversion and the bandwidth conversion to a lower-level radio station by a radio signal.
